(19) United States
(12) Patent Application Publication
(10) Pub. No.: US 2007/0136054 A1
(43) Pub. Date: Jun. 14, 2007

(54) Apparatus and method of searching for fixed codebook in speech codecs based on CELP

(76) Inventors: Hyun Woo Kim, Seoul (KR); Eung Don Lee, Daejeon (KR); Do Young Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/636,090

(22) Filed: Dec. 8, 2006

(30) Foreign Application Priority Data
Dec. 8, 2005 (KR) 10-2005-0119938
Jul. 3, 2006 (KR) 10-2006-0061746

(51) Int. Cl. G10L 19/00

(52) U.S. Cl. 704/219

(57) ABSTRACT

Provided are an apparatus and method of searching for a fixed codebook, the apparatus and method selecting an initial fixed codebook appropriate for a speech feature using a pulse replacement method, and determining a pulse replacement number, a threshold value, etc., to thereby improve sound quality and reduce an amount of unnecessary calculation. The apparatus includes: a speech feature information collector for collecting speech information from a user speech using a CELP (code excited linear prediction) speech codec; a speech feature determiner for determining a speech feature on the basis of the collected speech information; an initial fixed codebook determiner for selecting an initial fixed codebook on the basis of the determined speech feature; a fixed codebook search parameter determiner for determining parameters required for a pulse replacement method on the basis of the determined speech feature; and a fixed codebook determiner for determining a fixed codebook by the pulse replacement method using the selected fixed codebook search parameters and initial fixed codebook as initial values.

### CROSS-REFERENCE TO RELATED APPLICATION

This application claims priority to and the benefit of Korean Patent Application Nos. 2005-119938, filed Dec. 8, 2005, and 2006-61746, filed Jul. 3, 2006, the disclosures of which are incorporated herein by reference in their entirety.

### BACKGROUND

1. Field of the Invention

The present invention relates to a speech codec, and more particularly, to an apparatus and method of searching for a fixed codebook using a pulse replacement method in a speech codec based on code excited linear prediction (CELP).

2. Discussion of Related Art

In general, speech codecs are used to minimize an amount of information so as to conserve network bandwidth in speech communications using digital technology. Most speech codecs are based on a CELP technique which has the advantage of a high compression rate.

FIG. 1 is a block diagram of a speech codec based on CELP according to conventional art.

Referring to FIG. 1, first, a user speech (16 kHz (or 8 kHz) 16 bit signal) passes through a preprocessor (not shown in the drawing) and passes it through a high-pass filter or downscales it in order to eliminate a direct current (DC) component.

Subsequently, a linear prediction coefficient (LPC) extractor 100 calculates an LPC of the preprocessed signal, and a pitch information extractor 200 calculates a pitch interval and a pitch gain using the calculated LPC. Then, a fixed codebook information extractor 300 derives a fixed codebook index and gain from the calculated pitch interval and gain, converts a proper fixed codebook extracted by using them into a bitstream, and outputs the bitstream.

The speech codec constructed as described above quantizes three parameters indicating an LPC, a pitch period and gain, and an excitation signal, converts them into a bitstream, and compresses the bitstream. Typical codecs of this kind are G.729A, G.723.1, adaptive multi-rate (AMR), etc.

Meanwhile, a variety of techniques have been developed so that the fixed codebook information extractor 300 can search the proper fixed codebook (code excitation signal).

One such technique is a full search method used in 6.3 kbps G.723.1, which searches all possible pulse positions.

However, the full search method requires a considerable amount of calculation in comparison with sound quality, and thus takes an unnecessarily long time for a search operation.

In order to solve this problem, G.729 and 5.3 kbps G.723.1 use a focused search method. Assuming that a sub-frame of the codec has four tracks, the focused search method first searches the first three tracks for a pulse. Then, only when exceeds a previously calculated threshold value, the method searches the fourth track for a pulse.

The focused search method requires less calculation than the full search method, but has the drawbacks of still involving too much calculation and having non-uniform complexity.

In order to solve these problems, AMR-NB, AMR-WB, and G.729A use a depth-first tree search method. Assuming that a sub-frame of the codec has four tracks, the depth-first tree search method continuously searches tracks for a pulse position generally by two tracks. After selecting some pulse position candidates from one of the two tracks according to correlation values, the method searches the other track, and thus can drastically reduce amount of calculation and show uniform complexity.

A one-pulse replacement method is another fixed codebook search method. The method substitutes one pulse for another when an initial codebook is given, thereby continuously searching for a better codebook.

More specifically, the method first searches for an initial codebook, and then the most important pulse track in a current codebook. When the most important pulse track is found, a Qₖ value dependent on pulses of residual tracks other than the track is calculated. And, when the calculated Qₖ value is larger than that of the current codebook, a newly found codebook is substituted for the current codebook. Such a process is repeatedly performed. However, the method of first selecting the most important track and replacing one pulse shows considerably low performance due to inaccurate track selection. Therefore, a method of replacing pulses of all tracks without selecting only one track may be used as well.

Here, in the pulse replacement method, the factor that affects sound quality the most is initial codebook selection. In addition, whether or not a pulse is replaced and a repetition number are very important factors affecting amount of calculation and search time. So far, however, the above-described methods have not been developed to be appropriate for speech features.

For example, when an initial fixed codebook is selected in consideration of speech features, such as distinction between voiced and unvoiced speech, an initial value having similar features to an input signal is selected and reflected in a final fixed codebook by the one-pulse replacement method, so that better speech quality can be achieved. In addition, the pulse replacement method requires a threshold value determining whether or not a pulse is replaced and a maximum repetition number. When such parameters are selected appropriately for speech features, it is possible to reduce an amount of calculation resulting from unnecessary repetition. Since a fixed codebook has an insignificant affect on sound quality when only silence is input, an amount of calculation can be drastically reduced by further decreasing a pulse replacement repetition number.

### SUMMARY OF THE INVENTION

The present invention is directed to an apparatus and method of searching for a fixed codebook, the apparatus and method selecting an initial fixed codebook appropriate for speech features using a pulse replacement method, determining a pulse replacement number, a threshold value, etc., and thereby improving sound quality and reducing an amount of unnecessary calculation.

One aspect of the present invention provides an apparatus for searching for a fixed codebook in a speech codec based on code excited linear prediction (CELP), the apparatus comprising: a speech feature information collector for collecting speech information from a user speech using a CELP (code excited linear prediction) speech codec; a speech feature determiner for determining a speech feature on the basis of the collected speech information; an initial fixed codebook determiner for selecting an initial fixed codebook on the basis of the determined speech feature; a fixed codebook search parameter determiner for determining parameters required for a pulse replacement method on the basis of the determined speech feature; and a fixed codebook determiner for determining a fixed codebook by the pulse replacement method using the selected fixed codebook search parameters and initial fixed codebook as initial values.

The speech feature determiner may determine the speech feature using at least one of full-band energy, low-band energy, a zero-crossing rate, a linear prediction coefficient (LPC), line spectral pair (LSP), immittance spectral pair (ISP), pitch interval and pitch gain obtained from the CELP speech codec.

The fixed codebook determiner may update the initial fixed codebook using a one-pulse replacement method.

The fixed codebook determiner may determine a threshold value determining a maximum update repetition number and whether or not the update is made on the basis of the speech feature.

Another aspect of the present invention provides a method of searching for a fixed codebook in a speech codec based on CELP, the method comprising the steps of: (a) collecting speech information of a current frame from a user speech using a CELP speech codec; (b) determining a speech feature on the basis of the collected speech information; (c) determining an initial fixed codebook on the basis of the determined speech feature; (d) determining parameters required for a pulse replacement method on the basis of the determined speech feature; and (e) determining a fixed codebook by updating the determined initial fixed codebook by the one-pulse replacement method using the determined parameters.

In step (a), the speech information may be at least one of an LPC, an LSP, an ISP, a pitch interval, a pitch gain, full-band energy, low-band energy, a zero-crossing rate, and so on.

In step (b), the speech feature is determined as a voiced sound when a pitch gain of the speech information is more than a specific threshold value, and as an unvoiced sound when the pitch gain of the speech information is less than the specific threshold value. In addition, the speech feature is determined as a speech when energy and a zero-crossing rate are within a specific speech range, and as a silence when the energy and the zero-crossing rate are not within the specific speech range.

In step (c), the initial fixed codebook may be determined by weighting a plurality of initial fixed codebooks on the basis of the determined speech feature.

In step (d), a threshold value determining a maximum update repetition number and whether or not the initial fixed codebook is updated may be determined on the basis of the determined speech feature.

Step (e) may include the step of determining the fixed codebook by updating the determined initial fixed codebook by a one-pulse replacement method based on a determined threshold value.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of a speech codec based on code excited linear prediction (CELP) according to conventional art;

FIG. 2 is a block diagram of an apparatus for searching for a fixed codebook in a speech codec based on CELP according to an exemplary embodiment of the present invention; and

FIG. 3 is a flowchart showing a method of searching for a fixed codebook in a speech codec based on CELP according to an exemplary embodiment of the present invention.

### DETAILED DESCRIPTION OF EXEMPLARY EMBODIMENTS

Exemplary embodiments of an apparatus and method of searching for a fixed codebook in a speech codec based on code excited linear prediction (CELP) according to the present invention will be described with reference to appended drawings.

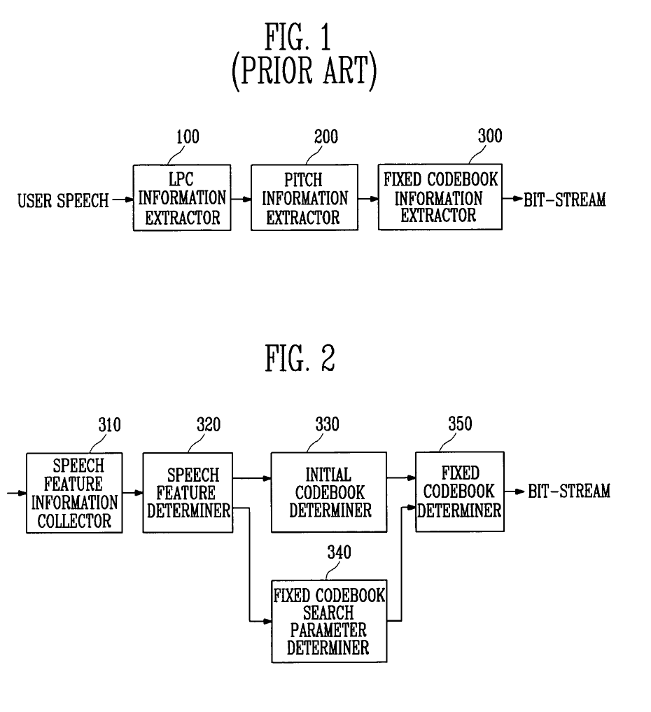

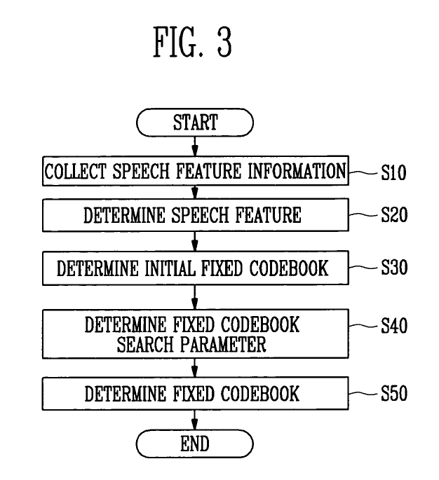

FIG. 2 is a block diagram of an apparatus for searching for a fixed codebook in a speech codec based on CELP according to an exemplary embodiment of the present invention.

Referring to FIG. 2, the apparatus comprises a speech feature information collector 310, a speech feature determiner 320, an initial fixed codebook determiner 330, a fixed codebook search parameter determiner 340, and a fixed codebook determiner 350. The speech feature information collector 310 collects speech information of a current frame from input speech using the speech codec based on a CELP technique. The speech feature determiner 320 determines a speech feature on the basis of the collected speech information. The initial fixed codebook determiner 330 selects an initial fixed codebook on the basis of the determined speech feature. The fixed codebook search parameter determiner 340 determines parameters required for a pulse replacement method on the basis of the determined speech feature. The fixed codebook determiner 350 determines a fixed codebook by the pulse replacement method using the determined fixed codebook search parameters and the selected initial fixed codebook as initial values.

Here, the speech feature determiner 320 directly/indirectly processes a linear prediction coefficient (LPC), line spectral pair (LSP), immittance spectral pair (ISP), pitch interval, pitch gain, etc. obtained from the CELP speech codec, or extracts parameters like full-band energy, low-band energy, a zero-crossing rate, etc. from the input speech, thereby determining a speech feature.

The fixed codebook determiner 350 updates the initial fixed codebook selected by the initial fixed codebook determiner 330 using the one-pulse replacement method, the update made with a threshold value determining a maximum update repetition number and whether or not the update is performed on the basis of the speech feature obtained from the speech feature determiner 320.

Operation of the apparatus constructed as described above for searching for a fixed codebook in a speech codec based on CELP will be described in detail with reference to appended drawings.

FIG. 3 is a flowchart showing a method of searching for a fixed codebook in a speech codec based on CELP according to an exemplary embodiment of the present invention.

Referring to FIG. 3, in step 10, an LPC, LSP, ISP, pitch interval, pitch gain, etc., which are speech feature information, are collected from a user speech using the speech codec based on the CELP technique. Here, the information on the LPC, LSP, ISP, pitch, and excitation signal is obtained as parameters and stored as a bitstream. An index and gain of a fixed codebook correspond to the excitation signal information.

Subsequently, in step 20, the obtained speech feature information of the LPC, LSP, ISP, pitch interval, pitch gain, etc. is directly/indirectly processed, and a feature of speech is determined. Here, when necessary, parameters like full-band energy, low-band energy, a zero-crossing rate, etc. are extracted from input speech, and a feature of speech is determined. For example, when a feature of speech is determined to indicate voiced or unvoiced sound, the pitch gain can be used. In addition, the LPC information (LSP, ISP), energy, zero-crossing rate, etc. can be used when the feature of speech is determined to indicate speech or silence.

In an exemplary embodiment, a speech feature is determined as a voiced sound when the pitch gain is more than a specific threshold value and a unvoiced sound when the pitch gain is less than the specific threshold value. Here, in order to determine whether a current frame is voiced or unvoiced sound, it is preferable to use whether a previous frame is voiced or unvoiced sound as well as to compare the pitch gain with the threshold value.

In another exemplary embodiment, one LPC can be used. More specifically, LPCs corresponding to voiced and unvoiced sound are calculated with reference to a database and compared with the LPC of the input speech, and a speech feature is determined.

In general, speech has various features like voiced/unvoiced sound, as described above. Thus, in consideration of such speech features, a threshold value, which determines an initial fixed codebook, a maximum pulse replacement number, and whether or not a pulse is replaced, etc. are selected, and thus better sound quality and a reduced amount of calculation are achieved.

Subsequently, in step 30, an initial fixed codebook is determined by weighting a plurality of initial fixed codebooks selected on the basis of the determined speech feature.

In an exemplary embodiment, a plurality of initial fixed codebooks are obtained in order of decreasing absolute value from an initial target vector to each pulse position.

Here, when the speech feature is determined as voiced or unvoiced sound, a large amount of energy is still distributed over pitch components of voiced sound even after having passed through a pitch filter.

Thus, when an interval between pulses equals a pitch interval, a weight is given to the corresponding initial fixed codebook. In addition, in the case of unvoiced sound, a little weight is further given to a high-frequency component in the same manner.

Among the plurality of initial fixed codebooks to which weights are given as described above, an initial fixed codebook to which the highest weight is given is determined as a final initial fixed codebook.

Subsequently, in step 40, parameters required for a pulse replacement method are determined on the basis of the determined speech features. Here, the parameters are a threshold value determining a maximum update repetition number and whether or not an update is performed, and so on.

Subsequently, in step 50, a pulse is repeatedly replaced using parameters such as a pulse replacement repetition number, the threshold value, etc. determined in step 40 in the initial fixed codebook determined in step 30, and an optimized fixed codebook is determined.

In an exemplary embodiment, first, the threshold value, which determines the maximum update repetition number, the initial fixed codebook, the maximum pulse replacement number, and whether or not a pulse is replaced on the basis of the speech feature determined in step 20, is determined.

Then, an initial value of the initial fixed codebook determined in step 30 is updated by the one-pulse replacement method.

During the update, a pulse is repeatedly replaced on the basis of the maximum update repetition number and the threshold value, which are information according to the update determined in step 40, and the optimized fixed codebook is determined.

Here, the one-pulse replacement method used to determine the fixed codebook is one of many algorithms for searching for a fixed codebook showing the best sound quality. The one-pulse replacement method selects one track in an initial fixed codebook and replaces it with another pulse, thereby obtaining a new fixed codebook. According to the one-pulse replacement method, selection of the initial fixed codebook is extremely important in order to improve sound quality.

The pulse replacement method searches not for a global optimal fixed codebook but for a local optimal fixed codebook using only one pulse. Thus, even though a local optimal fixed codebook is searched for in great detail, performance is not remarkably enhanced. Particularly, in the case of unvoiced sound, the effect of lengthy searching is insignificant.

Therefore, when a threshold value determining whether or not an update is made increases and a maximum repetition number decreases in the pulse replacement method, it is possible to reduce an amount of calculation without deterioration in performance. Consequently, by selecting different threshold values and different maximum repetition numbers according to speech feature information, it is possible to more significantly reduce an amount of calculation without deterioration in performance.

As described above, the apparatus and method of searching for a fixed codebook in a speech codec based on CELP according to the present invention have following effects.

First, in comparison with a conventional pulse replacement method not taking such speech features into consideration, the present invention selects an initial fixed codebook in consideration of speech features, thus showing better sound quality.

Second, the present invention determines a threshold value determining whether or not an update is made according to a speech information feature and a maximum repetition number, thereby reducing an amount of calculation without deterioration in performance.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for searching for a fixed codebook, comprising:
a speech feature information collector for collecting speech information from a user speech using a CELP (code excited linear prediction) speech codec;
a speech feature determiner for determining a speech feature on the basis of the collected speech information;
an initial fixed codebook determiner for selecting an initial fixed codebook on the basis of the determined speech feature;
a fixed codebook search parameter determiner for determining parameters required for a pulse replacement method on the basis of the determined speech feature; and
a fixed codebook determiner for determining a fixed codebook by the pulse replacement method using the selected fixed codebook search parameters and initial fixed codebook as initial values.

2. The apparatus of claim 1, wherein the speech feature determiner determines the speech feature using at least one of full-band energy, low-band energy, a zero-crossing rate, a linear prediction coefficient (LPC), linear spectral pair (LSP), interactive session protocol (ISP), pitch interval and pitch gain obtained from the CELP speech codec.

3. The apparatus of claim 1, wherein the fixed codebook determiner updates the initial fixed codebook using a one-pulse replacement method.

4. The apparatus of claim 3, wherein the fixed codebook search parameter determiner determines a threshold value determining a maximum update repetition number and whether or not the update is made on the basis of the speech feature.

5. A method of searching for a fixed codebook, comprising the steps of:
(a) collecting speech information of a current frame from a user speech using a CELP speech codec;
(b) determining a speech feature on the basis of the collected speech information;
(c) determining an initial fixed codebook on the basis of the determined speech feature;
(d) determining parameters required for a pulse replacement method on the basis of the determined speech feature; and
(e) determining a fixed codebook by updating the initial fixed codebook by the one-pulse replacement method based on the determined parameters.

6. The method of claim 5, wherein in step (a), the speech information is at least one of full-band energy, low-band energy, a zero-crossing rate, etc., an LPC, an LSP, an ISP, a pitch interval, and a pitch gain.

7. The method of claim 5, wherein in step (b), the speech feature is determined as a voiced sound when a pitch gain of the speech information is more than a specific threshold value, and a unvoiced sound when the pitch gain of the speech information is less than the threshold value.

8. The method of claim 5, wherein in step (c), the initial fixed codebook is determined by weighting a plurality of initial fixed codebooks on the basis of the determined speech feature.

9. The method of claim 5, wherein in step (d), a threshold value determining a maximum update repetition number and whether or not the update is made on the basis of the determined speech feature.

10. The method of claim 5, wherein in step (e), the fixed codebook is determined by updating the initial fixed codebook by one-pulse replacement method based on a determined threshold value.
